(19) United States
(12) Patent Application Publication
(10) Pub. No.: US 2026/0225174 A1
(43) Pub. Date: Aug. 6, 2026

(54) WELDING WIRE CONSUMPTION MONITORING SYSTEM

(71) Applicant: Deere & Company, Moline, IL (US)

(72) Inventors: Amit Pandita, Pune (IN); Abhijeet Hepat, Pune (IN); Sameet Chikane, Pune (IN); Anant Shyamkant Ingole, Pune (IN); Shravani Prashant Patel, Pune (IN)

(21) Appl. No.: 19/044,991

(22) Filed: Feb. 4, 2025

(51) Int. Cl. B23K 9/095; B23K 9/12

(52) U.S. Cl. CPC B23K 9/0956; B23K 9/124

(57) ABSTRACT

A welding wire consumption monitoring system includes a coupler mateable with a drive wheel of a welding wire feeder, a bracket attachable to the welding wire feeder, and a sensor mounted to the bracket and coupled to the coupler for detecting rotation of the drive wheel. The sensor is configured to generate one or more rotation signals and a controller is in communication with the sensor. The controller is configured to receive the one or more rotation signals, determine an available amount of wire based on the one or more rotation signals, compare the available amount of wire to a threshold amount of wire, and execute a corresponding response strategy.

### FIELD OF THE DISCLOSURE

The present disclosure relates to monitoring welding wire consumption, and in particular, to a system for monitoring welding wire consumption in an automated and manual welding process.

### BACKGROUND

Welding is a process that uses heat to melt and join metal pieces and components together. Welding is a common process used by industry in the manufacturing of a wide variety of products and machines including agricultural, construction, and forestry equipment, for example. In many industries robotics are employed to automate repetitive welding tasks and provide high quality, repeatable, and consistent welds. One example of a welding process that is commonly automated is Metal Inert Gas (MIG) welding. MIG welding is an arc welding process that uses a continuous solid wire electrode fed through a welding gun or torch and heated by an electric arc to form a molten weld pool.

### SUMMARY

In one implementation of the present disclosure, a welding wire consumption monitoring system includes a coupler mateable with a drive wheel of a welding wire feeder, a bracket attachable to the welding wire feeder, and a sensor mounted to the bracket and coupled to the coupler for detecting rotation of the drive wheel. The sensor is configured to generate one or more rotation signals and a controller is in communication with the sensor. The controller is configured to receive the one or more rotation signals, determine an available amount of wire based on the one or more rotation signals, compare the available amount of wire to a threshold amount of wire, and execute a corresponding response strategy.

In one example of this implementation, the controller is configured to determine the available amount of wire by calculating an amount of wire consumed based on the one or more rotation signals and subtracting the amount of wire consumed from a remaining amount of wire. In a second example, the controller is configured to display an indication that the wire supply needs to be replaced as the response strategy when the available amount of wire is less than the threshold amount of wire.

In a third example, the threshold amount of wire is an amount of wire needed to complete a welding process. In a fourth example, the controller is configured to prevent initiation of the welding process as the response strategy when the available amount of wire is less than the amount of wire needed to complete the welding process. In a fifth example, the sensor includes a housing mounted to the bracket and a rotating element coupled to the coupler for rotation with the drive wheel.

In a sixth example, the coupler engages an opening in the drive wheel of the welding wire feeder. In a seventh example, the coupler includes a first cylindrical portion having a first diameter and a second cylindrical portion having a second diameter smaller than the first diameter. In an eighth example, the first cylindrical portion is configured to engage the opening in the drive wheel and the second cylindrical portion is configured to couple to the sensor. In a further example, the first cylindrical portion includes a radially extending protrusion positioned to engage a corresponding feature in the drive wheel opening.

In another implementation of the present disclosure, an automated welding system includes a robot, a welding gun carried by the robot, a welding wire feeder connected to the welding gun, and a welding power source connected to the welding wire feeder. A coupler is mated with a drive wheel of the welding wire feeder, a bracket is attached to the welding wire feeder, and a sensor is mounted to the bracket and coupled to the coupler for detecting rotation of the drive wheel. The sensor is configured to generate one or more rotation signals and a controller is in communication with the sensor. The controller is configured to receive the one or more rotation signals, determine an available amount of wire based on the one or more rotation signals, compare the available amount of wire to a threshold amount of wire, and execute a corresponding response strategy.

In one example of this implementation, the controller is configured to determine the available amount of wire by calculating an amount of wire consumed based on the one or more rotation signals and subtracting the amount of wire consumed from a remaining amount of wire. In another example, the threshold amount of wire is an amount of wire needed to complete a welding process. In yet another example, the controller is configured to prevent initiation of the welding process as the response strategy when the available amount of wire is less than the amount of wire needed to complete the welding process. In a further example, the sensor includes a housing mounted to the bracket and a rotating element coupled to the coupler for rotation with the drive wheel.

In a further implementation of this disclosure, a method of monitoring welding wire consumption includes coupling a rotation sensor to a drive wheel of a welding wire feeder, receiving one or more rotation signals from the rotation sensor, determining an available amount of wire based on the one or more rotation signals, comparing the available amount of wire to a threshold amount of wire, and executing a corresponding response strategy.

In one example of this implementation, determining the available amount of wire includes calculating an amount of wire consumed based on the one or more rotation signals and subtracting the amount of wire consumed from a remaining amount of wire. In another example, the method includes displaying an indication that the wire supply needs to be replaced as the response strategy when the available amount of wire is less than the threshold amount of wire. In yet another example, the threshold amount of wire is an amount of wire needed to complete a welding process. In a further example, the method includes preventing initiation of the welding process as the response strategy when the available amount of wire is less than the amount of wire needed to complete the welding process.

In one example of this implementation, weld quality of both automated and/or semi-automated welding process is monitored using weld parameters obtained through sensors and machine learning methods and an appropriate response is generated.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a schematic representation of one example implementation of an automated welding system;

FIG. 2 is a side view of a welding wire feeder;

FIG. 3 is a side view of the welding wire feeder of FIG. 2 and components of a welding wire consumption monitoring system according to an example implementation;

FIG. 4 is a partial exploded perspective view of components of a welding wire consumption monitoring system according to an example implementation;

FIG. 5 is a front view of the bracket shown in FIGS. 3 and 4;

FIG. 6 is a side view of the coupler shown in FIG. 4;

FIG. 7 is a flow chart illustrating one implementation of a method for monitoring welding wire consumption; and

FIG. 8 is a block diagram illustrating one implementation of monitoring weld quality.

Corresponding reference numerals are used to indicate corresponding parts throughout the several views.

### DETAILED DESCRIPTION

For the purposes of promoting an understanding of the principles of the present disclosure, reference will now be made to the implementations described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates. Terms of degree, such as “substantially,” “about,” “approximately,” etc. are understood by those of ordinary skill to refer to reasonable ranges outside of the given value, for example, general tolerances associated with manufacturing, assembly, and use of the described implementations.

MIG welding, for example, is an arc welding process that uses a continuous solid wire electrode fed through a welding gun or torch and heated by an electric arc. Weld wire may be fed to the welding gun from spools or drums via a welding wire feeder. Wire spools or drums used in robotic cells may not be readily accessible to an operator due to the placement of the spools or drums in the robotic cell. In some cases, the placement of the spools or drums may result in the robot being shut down prior to an operator entering the cell to check how much wire is remaining. Thus, checking the amount of wire remaining can be inconvenient and time consuming. Furthermore, the operator is left to estimate how much wire is remaining and how much wire is necessary for the next weld.

If the robot runs out of wire during a welding operation the robot will stop and wait for an operator to reset the robot, in addition to replacing the supply of wire. Resetting the robot can include maneuvering the robot into position to complete the incomplete weld or completing the weld manually and positioning the robot to begin the next weld. In both cases resetting the robot takes away from the operator's productive time. When the robot runs out of wire while the operator is welding at another station, the robot cell is down until the operator notices the robot has stopped, which represents an additional loss of productivity.

The disclosed welding wire consumption monitoring system measures the amount of wire used and calculates an available amount of wire for the next welding operation. The system evaluates the amount of wire available as compared to the amount of wire needed to complete the next weld. If the amount of wire available is not sufficient to complete the next weld, the system stops the robot and notifies an operator that the robot needs more wire. Stopping the robot before it initiates the next weld eliminates the need to maneuver the robot after stopping mid-weld thus reducing robot downtime and saving valuable operator productive time and effort.

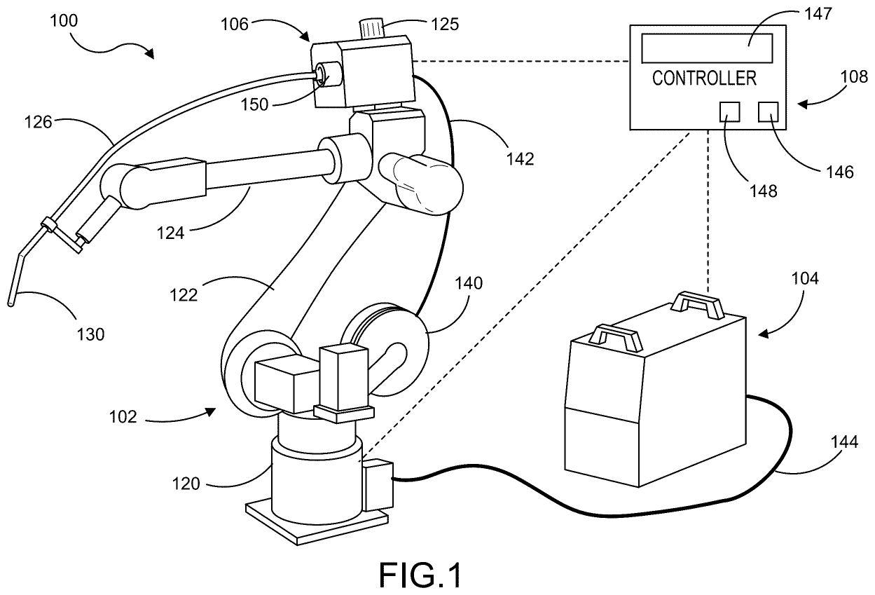

An example implementation of an automated welding system 100 is shown in FIG. 1. The welding system 100 can include a robot 102 and a welding gun 130 carried by the robot 102. A welding wire feeder 106 is connected to the welding gun 130 and feeds welding wire 142 from a spool 140 to the welding gun 130. A welding power source 104 is connected to the welding wire feeder 106 with a welding cable 144. The welding power source 104 provides the necessary power to generate the heat to liquefy the metal wire at the end of the welding gun 130 so that metal parts are joined (welded) together. The welding power source 104 typically uses three-phase power.

A torch cable 126 extends between the welding wire feeder 106 and the welding gun 130 to protect and shield the welding wire 142 running through the cable 126. The torch cable 126 is a flexible cable assembly used in MIG welding, which connects the welding power source 104 to the welding gun 130, via the welding wire feeder 106, allowing the robot 102 to maneuver the electrode wire 142 and deliver the welding current to a workpiece and typically while maintaining a steady flow of shielding gas.

In some implementations, the robot 102 can be a robot arm having a robot base 120 that supports robot arm segments 122 and 124 that are pivotably connected to each other. In some implementations, arm segment 124 may be rotatable with respect to arm segment 122 about multiple axes. The arm may have multiple axes of movement that allow it to reach different positions and angles to facilitate welding complex parts and shapes.

A controller 108 can be in communication with the robot 102, the welding power source 104, and the welding wire feeder 106 to coordinate the wire speed from the feeder 106, movements of the robot 102 needed to perform a weld, and the current provided by the welding power source 104. The controller 108 can include a voltage sensor 146 and an ambient temperature sensor 148 to provide information for weld quality analysis and classification. An annular inductive current sensor 150 can be positioned at the outlet of the wire feeder around the torch cable 126. In some implementations, the current, voltage, ambient temperature, and wire speed can be used to predict weld quality.

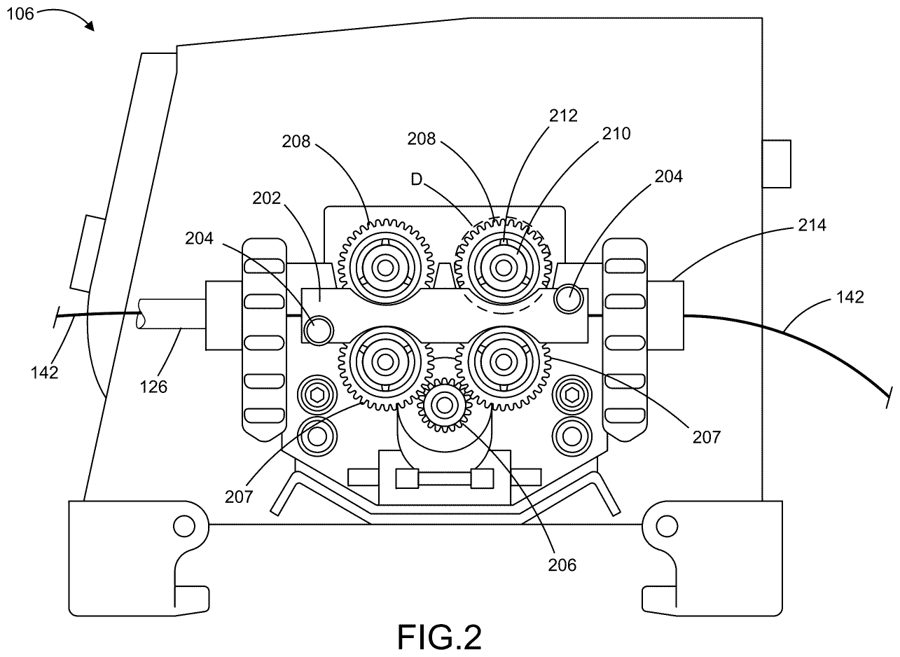

With reference to FIG. 2, the welding wire feeder 106 includes two pairs of counter-rotating drive wheels 207/208 driven by a pinion gear 206. The welding wire 142 feeds into the welding wire feeder 106 through a wire bushing 214 and in between each pair of drive wheels 207/208. The wire bushing 214 can include ball bearings to facilitate a smooth entry into the welding wire feeder 106. An outer wire guide 202 positions the welding wire 142 between the drive wheels 208. The outer wire guide 202 clamps against an inner wire guide (not shown) with thumb screws 204, for example.

The pinion gear 206 drives both pairs of drive wheels 207/208. The pinion gear 206 engages gear teeth on the lower drive wheels 207. The pinion gear 206 rotates clockwise thereby rotating the lower drive wheels 207 counter-clockwise. The lower drive wheels 207 each engage a corresponding upper drive wheel 208 causing the upper drive wheels 208 to rotate clockwise. In the depicted implementation, the clockwise rotation of the upper drive wheels 208 and the counter-clockwise rotation of the lower drive wheels 207 causes the welding wire 142 to feed from right to left and exit through the torch cable 126. The drive wheels 207/208 have a diameter D; therefore, each revolution of the drive wheels 207/208 will feed π* D units of welding wire 142 through the welding wire feeder 106.

The hub of each drive wheel 207/208 can include an opening 210 with features 212, for example. In some examples, the opening 210 can be an annular opening or a cylindrical opening and the features 212 can be in the form of rectangular keyways, for example. In still other examples, the features 212 can include a hole or threaded hole located along an axis of the drive wheel 207/208 and/or holes or threaded holes spaced radially from the axis of the drive wheels 207/208.

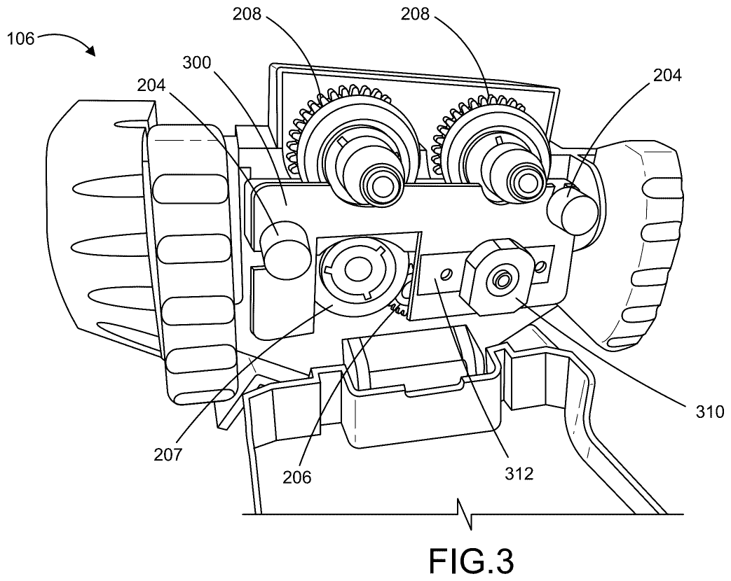

As shown in FIG. 3, a bracket 300 can be attached to the welding wire feeder 106 for mounting a sensor 310. The sensor 310 detects rotation of one of the drive wheels 207/208. In this implementation, the sensor 310 detects rotation of one of the lower drive wheels 207. The sensor 310 may be an incremental encoder (provides a pulse for each rotation), a magnetic sensor (detects magnetic pulses from a rotating gear), a photoelectric sensor (senses light interruption to detect rotation), a hall effect sensor (detects magnetic field changes from a rotating magnet), or an absolute encoder (provides the exact position of a drive wheel at any given time), for example.

In some implementations, the bracket 300 is mounted to the welding wire feeder 106 on top of the outer wire guide 202 (FIG. 2) using the thumb screws 204. The sensor 310 can be mounted directly to the bracket 300 or as shown in FIG. 3, via an intermediate bracket 312. The intermediate bracket 312 can facilitate mounting different types of sensors using the same bracket 300. Although the implementations of the disclosed system for monitoring welding wire consumption are shown and described herein in the context of an active wire feeder, the technology can also be applied to a passive monitor that includes a pair of wheels or rollers, for example, that rotate as a result of the wire being pulled through the wheels.

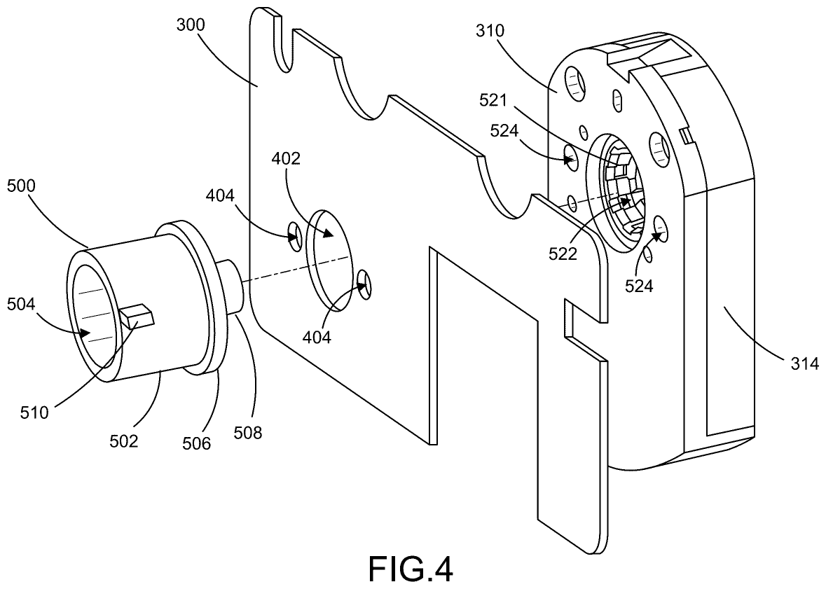

With further reference to FIG. 4, the sensor 310 can be mated to the drive wheel 207 with a coupler 500. The coupler 500 can include a first cylindrical portion 502, a flange 506, and a second cylindrical portion 508. The first cylindrical portion 502 is configured to engage the opening 210 in the drive wheel 207 (FIG. 2) and the second cylindrical portion 508 is configured to couple to the sensor 310. The sensor 310 may include a rotating element 521 that is coupled to the second cylindrical portion 508 for rotation with the drive wheel 207 via the coupler 500.

The sensor 310 may include a housing 314 that mounts to the bracket 300. The bracket 300 can include an aperture 402 through which the coupler 500 extends to engage the rotating element 521 of the sensor 310. The sensor housing 314 can include various mounting holes, such as mounting holes 524 that align with mounting holes 404 extending through the bracket 300. Therefore, the sensor 310 can be mounted to the bracket 300 with suitable fasteners, such as screws (not shown) threading into either the bracket 300 or the mounting holes 524 of the sensor housing 314, for example.

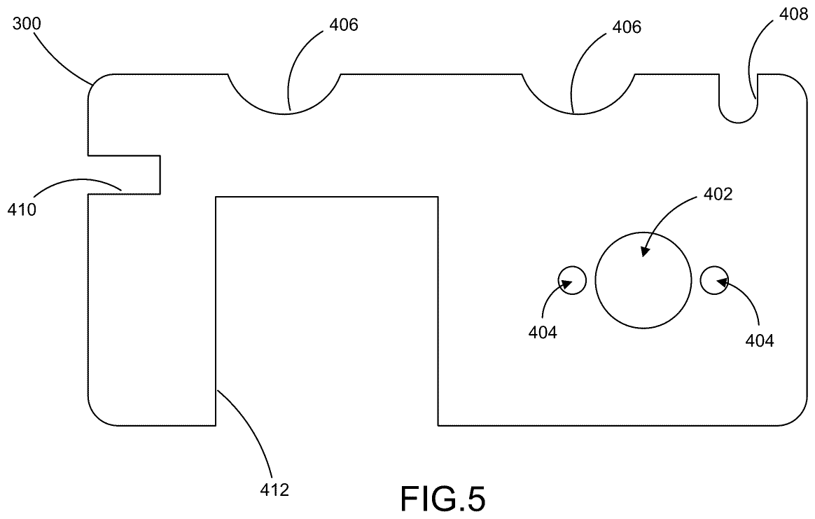

FIG. 5 is a front view of the bracket 300. The bracket 300 includes slots 408 and 410 positioned to align with the locations of the thumb screws 204 (FIG. 3). A pair of arcuate cutouts 406 are positioned toward the top of the bracket to provide clearance for portions of the upper drive wheels 208. A rectangular opening 412 is sized and positioned to provide clearance for one of the lower drive wheels 207 (see FIG. 3). As mentioned above, the aperture 402 and mounting holes 404 are centered around the axis of the lower drive wheel 207 and facilitate mounting the sensor 310 to the bracket 300.

In some implementations, the bracket 300 is a flat piece of material including the above-described features. The bracket 300 can be made of a suitable metal such as steel, stainless steel, or aluminum, for example. In some implementations, the bracket 300 can be made of a suitable plastic material such as high-density polyethylene (HDPE) or acrylonitrile butadiene styrene (ABS), for example.

It should be appreciated that the specific locations, shapes, sizes, and number of the bracket mounting features 402, 404, 408, 410 and the clearance features 406, 412 disclosed herein can vary to accommodate different types of welding wire feeders and welders, as well as different manufacturers. These features can also be varied to accommodate different sensor types and manufacturers.

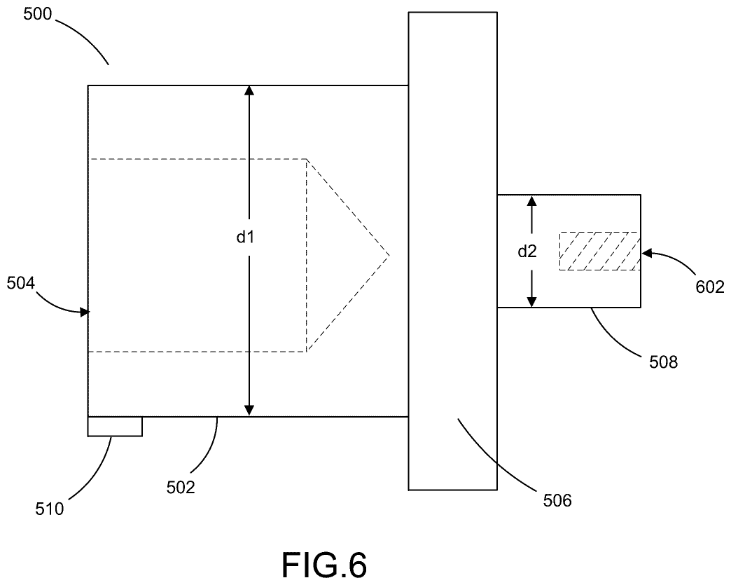

With reference to FIG. 6, the coupler 500 engages the opening 210 in the drive wheel 207 of the welding wire feeder 106. The first cylindrical portion 502 is configured to engage the opening 210 in the drive wheel 207 and the second cylindrical portion 508 is configured to couple to the sensor 310. The first cylindrical portion 502 has a first diameter d1 and the second cylindrical portion 508 has a second diameter d2 smaller than the first diameter d1. The diameters d1 and d2 are selected to mate with the drive wheel and sensor openings, respectively. They could be sized for a press fit or clearance fit, for example.

The first cylindrical portion 502 includes a radially extending protrusion 510 positioned to engage a corresponding feature 212 in the drive wheel opening 210. For example, the protrusion 510 can be a rectangular feature that engages with a keyway feature 212 to prevent the coupler 500 from rotating relative to the drive wheel 207. The coupler 500 includes a bore 504 that is concentric with the first cylindrical portion 502 to provide clearance such that the first cylindrical portion 502 can mate with the annular opening 210 of the drive wheel 207 (FIG. 2). The second cylindrical portion 508 can include a threaded bore 602 to receive a fastener for attaching the coupler 500 to the sensor 310, for example.

In some implementations the flange 506 has a diameter larger than the aperture 402 in the bracket to prevent the coupler 500 from coming out of the opening 210. The coupler can have snap fit features, be press fit, and/or secured to the drive wheel and/or sensor with fasteners.

The coupler 500 can be made of a suitable metal such as steel, stainless steel, or aluminum, for example. In some implementations, the coupler 500 can be made of a suitable plastic material such as high-density polyethylene (HDPE) or acrylonitrile butadiene styrene (ABS), for example.

It should be appreciated that the specific locations, shapes, sizes, and number of the features, such as for example the first cylindrical portion 502, the second cylindrical portion 508, diameters d1, d2, and protrusion 510, disclosed herein can vary to accommodate different types of welding wire feeders and welders, as well as different manufacturers. These features can also be varied to accommodate different sensor types and manufacturers.

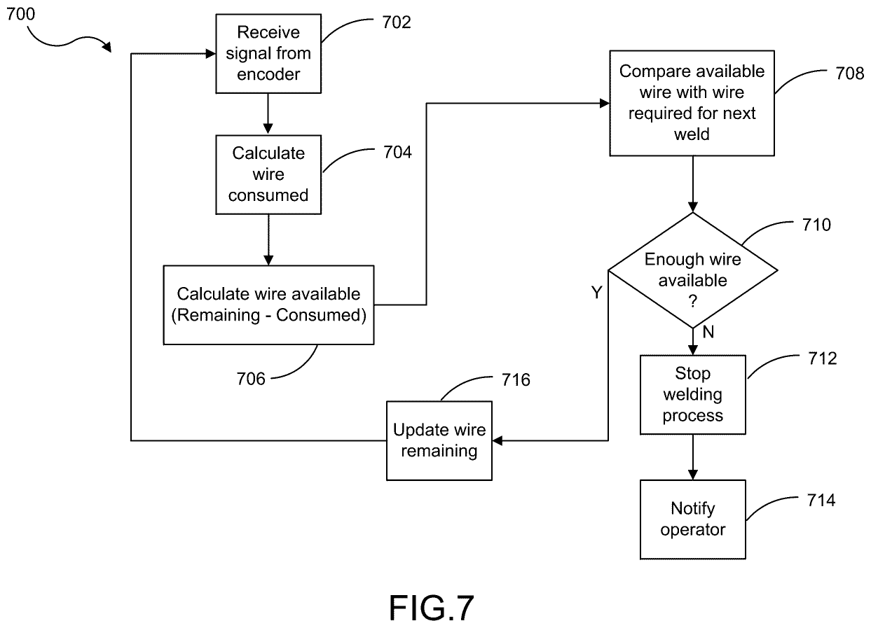

FIG. 7 illustrates one implementation of a method for monitoring welding wire consumption. The method 700 may include a set of instructions or blocks that are executable by a controller 108. The controller 108 may be located on e.g., the welder, robot, or remote therefrom. The controller may include a memory unit and processor unit. The memory unit may be capable of storing algorithms, models, processes, programs, software, look up tables, data, charts, diagrams, etc. In some implementations, the method 700 may include additional or fewer blocks. In another implementation, the blocks may be executed in a different order.

The method 700 begins at block 702 where a controller 108 receives one or more rotation signals from a rotation sensor 310 (e.g., an encoder) coupled to a drive wheel 207 of a welding wire feeder 106. The one or more rotation signals indicate how many revolutions of the drive wheel have occurred during a welding process, for example.

Following block 702, the method advances to block 704 where the controller 108 calculates an amount of wire consumed by multiplying the number of revolutions or rotations of the drive wheel (as indicated by the one or more rotation signals) by the circumference (π*D) of the drive wheel 207. The amount of wire consumed can be calculated using any suitable units such as inches, millimeters, or centimeters, for example. After block 704, the method proceeds to block 706.

In block 706, the controller determines an available amount of wire based on the one or more rotation signals. The controller calculates the available amount of wire by subtracting the amount of wire consumed (calculated in block 704) from a remaining amount of wire. The remaining amount of wire can be set initially as the amount of wire on a new spool or in a new barrel of welding wire where the amount of wire is known. The initial known remaining amount of wire can be entered into the controller 108 at a controller interface 147, for example. After block 706, the method proceeds to block 708.

In block 708, the controller compares the available amount of wire to a threshold amount of wire. In some implementations, the threshold amount of wire is an amount of wire needed to complete a welding process, such as the next weld in a series of welds to be performed in a robotic welding process. In some implementations, the amount of wired needed to perform each weld in a part or assembly can be stored in a database and be used to set the threshold amount of wire after each previous weld is completed. In some implementations, historical data may be referenced to determine how much wire is needed for the part being welded in comparison to how much welding wire is left on the spool.

In other implementations, the threshold amount of wire may be a set value determined by an operator to provide advanced notification of the end of the wire. This value can be set to account for tolerance in the amount of wire specified on the spool or barrel as well as wire consumed during setup of the welder. The set value for the threshold can be entered into the controller 108 at a controller interface 147, for example. After block 708, the method proceeds to block 710.

In block 710, the controller 108 determines if the available amount of wire is less than or greater than the threshold amount of wire. For example, if the available amount of wire is less than the amount of wire needed to complete the welding process, the method proceeds to block 712, otherwise the method proceeds to block 716.

In block 712, the controller 108 prevents initiation of the welding process as a response strategy when the available amount of wire is less than the amount of wire needed to complete the next welding process. The controller 108 can stop the robot 102 in the air move between the previous weld and the next weld operation. An air move instruction is a high-speed movement that a welding robot uses to move, while away from the part, from one weld to another. Air moves help optimize the welding process by allowing the robot to avoid obstructions prior to initiating a subsequent weld. After block 712, the method proceeds to block 714.

In block 714, the controller displays an indication that the wire supply needs to be replaced as a response strategy when the available amount of wire is less than the threshold amount of wire. The indication can be displayed on interface 147 and/or displayed via a notification light 125 mounted on the robot, for example.

In block 716, where the controller 108 determines in block 710 that the available amount of wire is greater than the threshold amount of wire, the controller updates the remaining amount of wire by subtracting the consumed amount of wire (calculated in block 704). After block 716, the method may return to block 702.

When an operator sets up a part for welding, an information message may be displayed on the interface 147 indicating after how many minutes of running the welding program, wire from the spool will be exhausted. This information will enable the operator to plan accordingly leading to reduction in robot downtime and operator interruptions. In some implementations the disclosed system tracks the wire consumption based on the part being welded. The system can also estimate in advance when the robot will run out of wire based on the part being welded, thereby providing the operator advanced warning so that the operator can plan for a timely spool or drum replacement even before the robot is stopped. When the operator starts a new welding cycle, information regarding the amount of wire left on the spool or drum may be displayed on the interface 147, for example. If the amount of wire remaining on the spool or drum is not sufficient for welding the current part, a message may be displayed for the time after which the wire supply will need to be replaced.

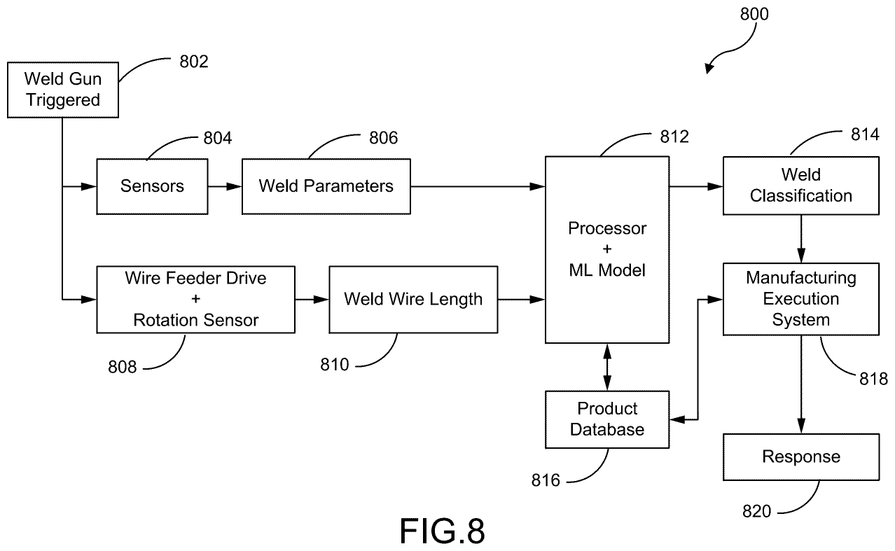

FIG. 8 illustrates one implementation of a method for monitoring weld quality. The method 800 may include a set of instructions or blocks that are executable by a controller 812. The controller 812 may be located on e.g., the welder, robot, or remote therefrom. The controller may include a memory unit and a processor unit. The memory unit may be capable of storing algorithms, models, processes, programs, software, look up tables, data, charts, diagrams, etc. In some implementations, the method 800 may include additional or fewer blocks. In another implementation, the blocks may be executed in a different order.

The method 800 begins at block 802 when the welding gun is triggered. When the welding gun is triggered, the method advances to block 804 and block 808. Beginning in block 804, the controller 812 receives weld parameters 806 via various sensors 804, which may include the voltage sensor 146, current sensor 150, and ambient temperature sensor 148, for example. Thus, the weld parameters 806 can include information corresponding to the sensors 804.

Beginning in block 808, the controller 812 receives rotation signals indicative of a consumed welding wire length 810 from the rotation sensor 310 coupled to the welding wire feeder 106.

The controller 812 can use a model to provide a weld classification 814 using the weld parameters 806 from the sensors 804 as well as the weld wire length 810. In some implementations, the controller 812 can receive signals from one or more of the current sensor, voltage sensor, or ambient temperature sensor and apply a model (e.g., machine learning model) to classify one or more welds. The model can be an algorithm or a trained machine learning model, such as logistic regression, naive bayes, decision trees, support vector machines (SVM), random forest, neural networks, and K-nearest neighbors, for example. In some implementations, a machine learning model can provide a binary classification. For example, the weld can be classified as acceptable or unacceptable. In other implementations, the model can provide a multi-class classification. For example, the weld can be classified by defect, such as incomplete penetration, incomplete fusion, undercut, spatter, slag inclusions, cracks, porosity, and overlap, for example.

Prior to deployment, the model can be exposed to training data, where it adjusts its internal parameters to minimize the difference between its weld quality predictions and the actual known outcomes labeled in the training data (e.g., supervised learning). Other learning models can be utilized for the purpose of learning, classification, and prediction.

The weld classification 814 can be fed into a manufacturing execution system 818 which shares information with a product database 816. The product database 816 can provide information to the controller 812, such as part specific information including weld path, weld parameters (e.g., voltage, current, temperature), and wire speed, for example. The product database 816 can also include the number of welds each product or assembly should have. The system can monitor the number of welds performed for a given part or assembly based on the number of momentary spikes in current associated with striking an arc for a new weld. The product database 816 can also include the amount of wire that should be used for a given part or assembly, which can be compared to how much wire is actually used as measured.

The manufacturing execution system 818 can also direct a response strategy 820 based on the weld classification 814 and product database information 816. In some implementations, the response strategy can include displaying an indication that the wire supply needs to be replaced when the available amount of wire is less than the threshold amount of wire needed to complete the next welding process in a series of welds of a component or part welding operation. The strategy can also include preventing initiation of the welding process when the available amount of wire is less than the amount of wire needed to complete the welding process.

In some implementations, the response strategy can include displaying an indication that a weld has been classified as unacceptable and halting the welding operations until an operator can evaluate the situation. In another example, the controller 812 can adjust welding parameters (e.g., voltage, current, wire speed) to improve welding performance when a weld has been classified as having a defect based on which defect the weld is classified as having (e.g., incomplete penetration, incomplete fusion, undercut, spatter, slag inclusions, cracks, porosity, and overlap). In another implementation, the response strategy can be to notify an operator whether the number of welds (as indicated by momentary spikes in current) is correct for a given part or assembly. In still other implementations, the quality of the welds can be indicated as either correct or incorrect. In further examples, possible adjustments to the welding process can be suggested based on the model output.

In the present disclosure, the implementations described herein may be used on any equipment that feeds welding wire. For example, the implementations described herein may be used on stand alone welding wire feeders and welding machines that include wire feeders. Furthermore, the implementations described herein may be used on wire feeding equipment of various manufacturers and designs.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

What is claimed is:

1. A welding wire consumption monitoring system, comprising:
a coupler mateable with a drive wheel of a welding wire feeder;
a bracket attachable to the welding wire feeder;
a sensor mounted to the bracket and coupled to the coupler for detecting rotation of the drive wheel, wherein the sensor is configured to generate one or more rotation signals; and
a controller in communication with the sensor, the controller configured to:
receive the one or more rotation signals;
determine an available amount of wire based on the one or more rotation signals;
compare the available amount of wire to a threshold amount of wire; and
execute a corresponding response strategy.

2. The system of claim 1, wherein the controller is configured to determine the available amount of wire by calculating an amount of wire consumed based on the one or more rotation signals and subtracting the amount of wire consumed from a remaining amount of wire.

3. The system of claim 1, wherein the controller is configured to display an indication that the wire supply needs to be replaced as the response strategy when the available amount of wire is less than the threshold amount of wire.

4. The system of claim 1, wherein the threshold amount of wire is an amount of wire needed to complete a welding process.

5. The system of claim 4, wherein the controller is configured to prevent initiation of the welding process as the response strategy when the available amount of wire is less than the amount of wire needed to complete the welding process.

6. The system of claim 1, wherein the sensor includes a housing mounted to the bracket and a rotating element coupled to the coupler for rotation with the drive wheel.

7. The system of claim 1, wherein the coupler engages an opening in the drive wheel of the welding wire feeder.

8. The system of claim 7, wherein the coupler includes a first cylindrical portion having a first diameter and a second cylindrical portion having a second diameter smaller than the first diameter.

9. The system of claim 8, wherein the first cylindrical portion is configured to engage the opening in the drive wheel and the second cylindrical portion is configured to couple to the sensor.

10. The system of claim 9, wherein the first cylindrical portion includes a radially extending protrusion positioned to engage a corresponding feature in the drive wheel opening.

11. An automated welding system, comprising:
a robot;
a welding gun carried by the robot;
a welding wire feeder connected to the welding gun;
a welding power source connected to the welding wire feeder;
a coupler mated with a drive wheel of the welding wire feeder;
a bracket attached to the welding wire feeder;
a sensor mounted to the bracket and coupled to the coupler for detecting rotation of the drive wheel, wherein the sensor is configured to generate one or more rotation signals; and
a controller in communication with the sensor, the controller configured to:
receive the one or more rotation signals;
determine an available amount of wire based on the one or more rotation signals;
compare the available amount of wire to a threshold amount of wire; and
execute a corresponding response strategy.

12. The system of claim 11, wherein the controller is configured to determine the available amount of wire by calculating an amount of wire consumed based on the one or more rotation signals and subtracting the amount of wire consumed from a remaining amount of wire.

13. The system of claim 11, wherein the threshold amount of wire is an amount of wire needed to complete a welding process.

14. The system of claim 13, wherein the controller is configured to prevent initiation of the welding process as the response strategy when the available amount of wire is less than the amount of wire needed to complete the welding process.

15. The system of claim 11, wherein the sensor includes a housing mounted to the bracket and a rotating element coupled to the coupler for rotation with the drive wheel.

16. A method of monitoring welding wire consumption, the method comprising:
coupling a rotation sensor to a drive wheel of a welding wire feeder;
receiving one or more rotation signals from the rotation sensor;
determining an available amount of wire based on the one or more rotation signals;
comparing the available amount of wire to a threshold amount of wire; and
executing a corresponding response strategy.

17. The method of claim 16, wherein determining the available amount of wire includes calculating an amount of wire consumed based on the one or more rotation signals and subtracting the amount of wire consumed from a remaining amount of wire.

18. The method of claim 16, further comprising displaying an indication that the wire supply needs to be replaced as the response strategy when the available amount of wire is less than the threshold amount of wire.

19. The method of claim 16, wherein the threshold amount of wire is an amount of wire needed to complete a welding process and further comprising preventing initiation of the welding process as the response strategy when the available amount of wire is less than the amount of wire needed to complete the welding process.

20. The method of claim 16 further comprising receiving signals from one or more of a current sensor, voltage sensor, or ambient temperature sensor and applying a machine learning model to classify one or more welds.
